(19) United States
(12) Patent Application Publication
(10) Pub. No.: US 2019/0019136 A1
(43) Pub. Date: Jan. 17, 2019

(54) TANK DELIVERY PLANNING DEVICE FOR LP GAS AND TANK DELIVERY PLANNING METHOD FOR LP GAS

(71) Applicant: Azbil Kimmon Co., Ltd., Tokyo (JP)

(72) Inventor: Eiji MURAKAMI, Tokyo (JP)

(73) Assignee: Azbil Kimmon Co., Ltd., Tokyo (JP)

(21) Appl. No.: 16/027,591

(22) Filed: Jul. 5, 2018

(30) Foreign Application Priority Data
Jul. 12, 2017 (JP) 2017-136316

(51) Int. Cl. G06Q 10/08; G06N 5/04

(52) U.S. Cl. CPC G06Q 10/083; G06N 5/04

(57) ABSTRACT

An acquisition portion obtains daily gas consumption amounts of tanks from gas meters. A consumption amount predicting portion predicts future daily gas consumption amounts for a first set number of days using latest gas consumption amounts having the same days of the week among the gas consumption amounts obtained by the acquisition portion. A replacement day predicting portion predicts the day on which the remaining gas amount in the tank becomes zero using the gas consumption amounts and the future gas consumption amounts for the set number of days. An extracting portion extracts the installation address of the tank for which the remaining amount is predicted to become zero on the day after a second set of days from a set period. A planning portion creates a delivery plan for delivering a new tank to the address extracted by the extracting portion 14 within the set period.

### CROSS-REFERENCE TO RELATED APPLICATION

The present application claims the benefit of and priority to Japanese Patent Application No. 2017-136316, filed on Jul. 12, 2017, the entire contents of which are incorporated by reference herein.

### TECHNICAL FIELD

The present invention relates to a device that creates delivery plans of LP (Liquefied Petroleum) gas tanks.

### BACKGROUND

There is a generally known LP gas supply system in which gas in a container is supplied to a gas meter through a pipe and then supplied to a terminal gas combustion chamber through a pipe from the gas meter as described in, for example, PTL 1.

Before an LP gas tank becomes empty, the tank needs to be replaced with another new one filled with gas. Since the timing for delivering a new tank is empirically determined by the gas supply operator, replacement with a new tank may be performed in the state in which much gas remains in the tank for use, thereby causing waste of delivery cost, unnecessary inventory of gas remaining in recovered tanks, and reduction of efficiency.

On the other hand, for example, PTL 2 describes a technique that calculates the past monthly average consumption amount of LP gas and sets the expected recovery/replacement date of a tank based on the last replacement date and the monthly average consumption amount.

### CITATION LIST

### Patent Literature

[PTL 1] Japanese Patent No. 3525404

[PTL 2] JP-A-2002-279025

### SUMMARY

However, when the expected recovery/replacement date is obtained simply based on the past monthly average consumption amount, as described in PTL 2, it is difficult to obtain the expected recovery/replacement date accurately. This is because the user's future consumption behaviors cannot be predicted appropriately based on the past monthly average consumption amount. Since the expected recovery/replacement date cannot be set accurately, as described above, a recovery/replacement plan made by the method in PTL 2 also becomes inefficient.

The invention addresses the above problem with an object of obtaining an efficient tank delivery plan for LP gas.

A tank delivery planning device for LP gas according to the invention comprises an acquisition portion that obtains daily gas consumption amounts; a consumption amount predicting portion that predicts future daily gas consumption amounts for a first set number of days using the latest gas consumption amount of the same day of the week among the gas consumption amounts obtained by the acquisition portion; a replacement day predicting portion that predicts a day on which a remaining gas amount in a tank becomes zero using the gas consumption amounts obtained by the acquisition portion and the future gas consumption amounts for the first set number of days predicted by the consumption amount predicting portion; an extracting portion that extracts an installation address of the tank for which the day on which the remaining gas is predicted to become zero by the replacement day predicting portion is a second set of days after a set period; and a planning portion that solves a delivery planning problem delivering the tank within the set period to the address extracted by the extracting portion and creates a delivery plan.

According to the invention, an efficient tank delivery plan for LP gas can be obtained by predicting future daily gas consumption amounts for the first set number of days using the latest gas consumption amount of the same day of the week among the obtained gas consumption amounts and creating a delivery plan based on the predicted gas consumption amounts.

### BRIEF DESCRIPTION OF THE DRAWINGS

FIG. 1 is a block diagram illustrating the structure of a tank delivery planning device according to embodiment 1.

FIG. 2 is a flowchart illustrating an example of processing by the tank delivery planning device according to embodiment 1.

FIGS. 3 and 4 are tables used to describe processing by the tank delivery planning device according to embodiment 1 using specific values.

FIG. 5 illustrates a linear regression model that represents the relationship between the number of elapsed days, the day of the week, and the remaining gas amount in the tank.

FIG. 6 illustrates a nonlinear regression model that represents the relationship between the number of elapsed days, the day of the week, and the remaining gas amount in the tank.

### DETAILED DESCRIPTION

### Embodiment 1

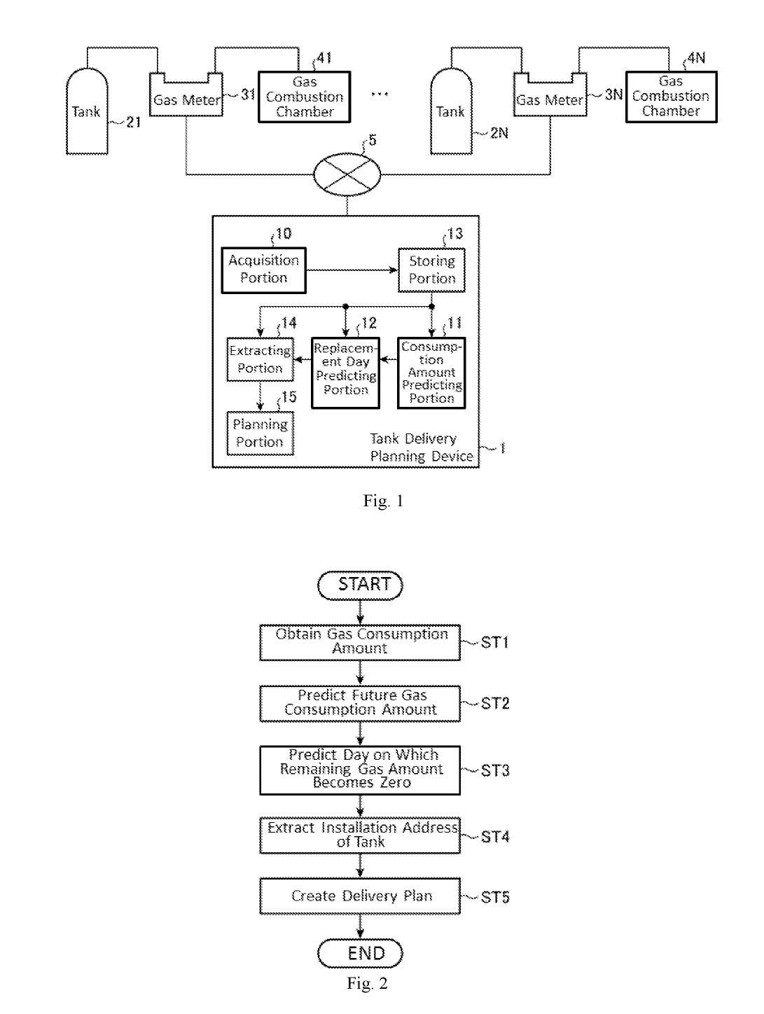

FIG. 1 is a block diagram illustrating the structure of a tank delivery planning device 1 for LP gas (also simply referred to below as gas) according to embodiment 1. FIG. 1 also illustrates LP gas tanks 21 to 2N, gas meters 31 to 3N, gas combustion chambers 41 to 4N, a communication line 5, and the like.

The number of gas meters to be connected to the tank delivery planning device 1 via the communication line 5 and the number of tanks that are measurement targets of the gas meters are N (N is a positive integer) and FIG. 1 only illustrates the tanks 21 and 2N and the gas meters 31 and 3N for simplicity.

The gas in the tanks 21 to 2N is supplied to the gas combustion chambers 41 to 4N via the gas meters 31 to 3N. The gas meters 31 to 3N measure the amounts of gas flowing out of the tanks 21 to 2N and transmit the gas consumption amounts to the tank delivery planning device 1 via the communication line 5.

The gas combustion chambers 41 to 4N are, for example, gas cooking stoves, gas water heaters, or gas stoves.

The tank delivery planning device 1 comprises an acquisition portion 10, a consumption amount predicting portion 11, a replacement day predicting portion 12, a storing portion 13, an extracting portion 14, and a planning portion 15. The tank delivery planning device 1 is constructed in a server managed by the gas supply operator or the like. This server is communicably connected to the gas meters 31 to 3N via the communication line 5.

The acquisition portion 10 obtains the daily gas consumption amounts of the tanks 21 to 2N from the gas meters 31 to 3N via the communication line 5. It should be noted here that the acquisition portion 10 may receive the gas consumption amounts of one day from the gas meters 31 to 3N once a day or may receive the gas consumption amount of substantially one day by receiving the gas consumption amounts in a shorter cycle (for example, at intervals of one hour) from the gas meters 31 to 3N and summarizing the amounts of one day. That is, the gas meters 31 to 3N are configured to transmit information indicating the daily gas consumption amounts. After obtaining the daily gas consumption amounts, the acquisition portion 10 accumulates the gas consumption amounts in the storing portion 13.

The storing portion 13 can be accessed by the acquisition portion 10, the consumption amount predicting portion 11, the replacement day predicting portion 12, the extracting portion 14, and the planning portion 15. In addition, the storing portion 13 stores information about each of the tanks 21 to 2N, such as the day on which the previous tank was replaced with the tank (that is, the use start day of the tank), the capacity of the tank, and the installation address of the tank.

The consumption amount predicting portion 11 predicts the future gas consumption amount daily. At this time, the consumption amount predicting portion 11 performs prediction using the latest gas consumption amount of the same day of the week that needs to be predicted among the gas consumption amounts obtained by the acquisition portion 10. The prediction method for the gas consumption amount by the consumption amount predicting portion 11 will be described in detail later. The consumption amount predicting portion 11 outputs the predicted future gas consumption amount to the replacement day predicting portion 12.

The replacement day predicting portion 12 predicts the day on which the remaining gas amount in each of the tanks 21 to 2N becomes zero, that is the replacement day, based on the gas consumption amount obtained by the acquisition portion 10 and the future gas consumption amount predicted by the consumption amount predicting portion 11. The replacement day predicting portion 12 outputs the predicted replacement days of the tanks 21 to 2N to the extracting portion 14.

The extracting portion 14 performs extraction from the installation addresses of the tanks 21 to 2N stored in the storing portion 13, based on the replacement day predicted by the replacement day predicting portion 12. The extracting portion 14 outputs the extracted address to the planning portion 15.

The planning portion 15 creates a delivery plan for delivering the tank to the address extracted by the extracting portion 14.

Details on the processing by the extracting portion 14 and the planning portion 15 will be described later.

The tank delivery planning device 1 comprises a communication device, a memory, a processor, and the like and the processing of the acquisition portion 10, the consumption amount predicting portion 11, the replacement day predicting portion 12, the extracting portion 14, and the planning portion 15 is performed by causing the processor to execute programs stored in the memory. It should be noted here that a plurality of processors and a plurality of memories may be combined with each other.

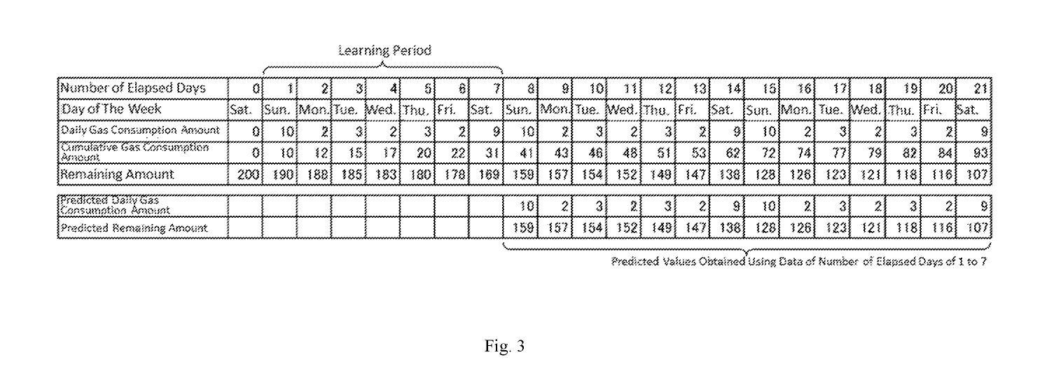

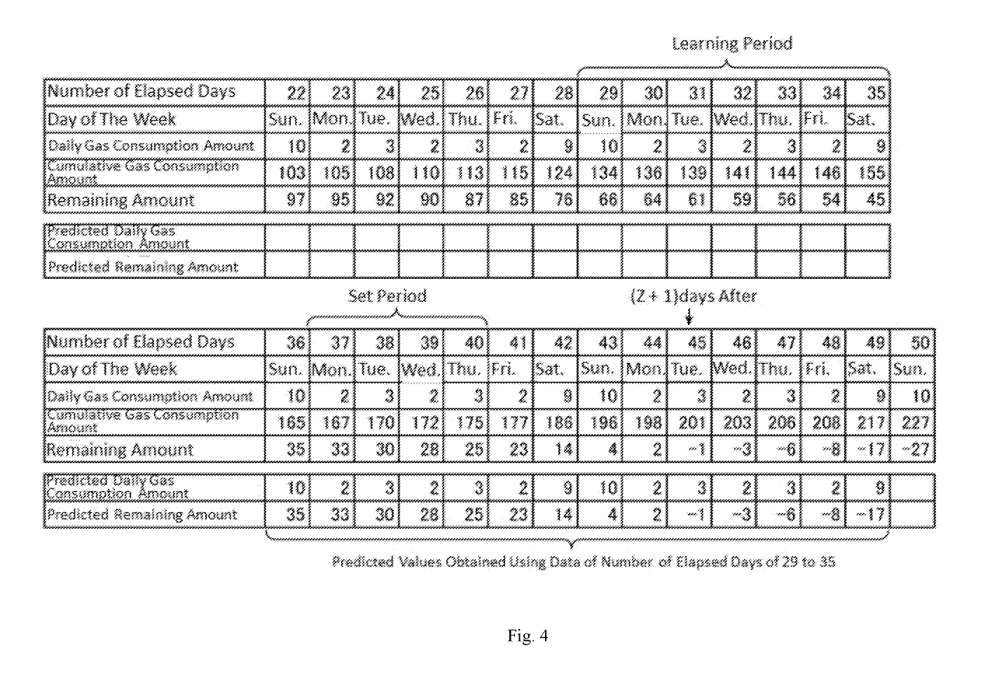

Next, an example of processing by the tank delivery planning device 1 configured as described above will be described with reference to the flowchart illustrated in FIG. 2 and the tables illustrated in FIGS. 3 and 4.

The acquisition portion 10 obtains the daily gas consumption amounts of the tanks 21 to 2N from the gas meters 31 to 3N via the communication line 5 (step ST1). The obtained gas consumption amounts are associated with information of the days of the week, and the like, and accumulated in the storing portion 13.

Next, the consumption amount predicting portion 11 predicts the future daily gas consumption amounts for the first set number of days based on the gas consumption amounts obtained and accumulated in the storing portion 13 by the acquisition portion 10 (step ST2). The predicted gas consumption amounts are output to the replacement day predicting portion 12.

FIGS. 3 and 4 are tables used to describe processing by the tank delivery planning device 1 using specific values and illustrates the data about the tank 21.

The following description assumes that the remaining amount in the tank 21 for the number of elapsed days of 0 is 200 liters (that is, the capacity of the tank 21 is 200 liters). The number of elapsed days represents the number of days elapsed after the use of the tank 21 is started.

As illustrated in FIG. 3, it is assumed that the gas consumption amounts of the number of elapsed days of 1 to the numbers of elapsed days of 7 are 10 liters, 2 liters, 3 liters, 2 liters, 3 liters, 2 liters, and 9 liters, respectively. The day that corresponds to the number of elapsed days of 1 is a Sunday and the day that corresponds to the number of elapsed days of 7 is a Saturday.

The consumption amount predicting portion 11 starts predicting the future daily gas consumption amounts for the first set number of days for the tank 21 when the gas consumption amounts of at least each of Monday to Sunday are all obtained. The first set number of days is determined based on “the number of days that needs to be predicted” that has been preset. For example, the first set number of days may be set to the number of days that needs to be predicted as is or may be set to the number of days that needs to be predicted plus several days. The following description assumes that the number of days that needs to be predicted is one week and the first set number of days is twice the number of days that needs to be predicted.

When the gas consumption amounts of up to the number of elapsed days of 7 measured by the gas meter 31 are obtained by the acquisition portion 10, the consumption amount predicting portion 11 daily predicts the future gas consumption amounts for two weeks that are the first set number of days, that is, the gas consumption amounts on the number of elapsed days of 8 to the number of elapsed days of 21. At this time, the consumption amount predicting portion 11 performs prediction on the assumption that the same gas consumption amount as the latest gas consumption amount on the same day of the week among the gas consumption amounts obtained by the acquisition portion 10 occurs. This is because gas consumption behaviors generally depend on the day of the week.

For example, since the day corresponding to the number of elapsed days of 8 is a Sunday, a gas consumption amount of 10 liters on the day corresponding to the number of elapsed days of 1 obtained latest as the gas consumption amount on a Sunday is predicted as the gas consumption amount on the number of elapsed days of 8.

Similarly, since the day corresponding to the number of elapsed days of 9 is a Monday, a gas consumption amount of 2 liters on the day corresponding to the number of elapsed days of 2 obtained latest as the gas consumption amount on a Monday is predicted as the gas consumption amount on the number of elapsed days of 9.

This is also true of the number of elapsed days of 10 to the number of elapsed days of 21, so the daily gas consumption amounts on the number of elapsed days of 8 to the number of elapsed days of 21 are predicted using the number of elapsed days of 1 to the number of elapsed days of 7 as the learning period.

Such prediction is performed each time the acquisition portion 10 newly obtains the daily gas consumption amount. That is, when the gas consumption amount on that day is transmitted from the gas meter 31 on the day corresponding to the number of elapsed days of 8, the consumption amount predicting portion 11 predicts the gas consumption amounts on the number of elapsed days of 9 to the number of elapsed days of 22 using the gas consumption amounts from the number of elapsed days of 2 to the number of elapsed days of 8. In this way, each time the acquisition portion 10 newly obtains the daily gas consumption amount, the predicted value is updated.

The following description assumes that the consumption amount predicting portion 11 performs prediction, as described above, on the day corresponding to the number of elapsed days of 36 for the tank 21. In this case, the gas consumption amounts of the tank 21 on the number of elapsed days of 36 to the number of elapsed days of 49 are predicted, as illustrated in FIG. 4, using the gas consumption amounts on the number of elapsed days of 29 to the number of elapsed days of 35. It should be noted here that the gas consumption amounts of the tanks 22 to 2N other than the tank 21 are also predicted similarly.

The replacement day predicting portion 12 predicts the day on which the remaining gas amount in each of the tanks 21 to 2N becomes zero using the gas consumption amounts obtained by the acquisition portion 10 and the future gas consumption amounts for the first set number of days predicted by the consumption amount predicting portion 11 (step ST3). The days on which the remaining gas amounts are predicted to become zero for the tanks 21 to 2N are output to the extracting portion 14.

The replacement day predicting portion 12 can predict the daily remaining gas amounts up to the first set number of days ahead by subtracting the cumulative value of the gas consumption amounts obtained thus far by the acquisition portion 10 and subtracting the predicted values of the gas consumption amounts up to the first set number of days ahead predicted by the consumption amount predicting portion 11 from the capacity of each of the tanks 21 to 2N. For example, for the tank 21, the remaining gas amount is predicted to become zero on the day corresponding to the number of elapsed days of 45, as illustrated in FIG. 4.

Delivery timing is set as a period in the tank delivery planning device 1. The period set in this way is simply referred to below as the “set period”. The set period indicates the number of days usable as a period basket for a delivery plan and a new tank needs to be delivered to the extracted address described later within this set period. In addition, the minimum number of days before empty for indicating that a new tank needs to be delivered up to Z days before the tank in use becomes empty is set in the tank delivery planning device 1. The following description assumes that the set period is four days starting from tomorrow and the minimum number of days before empty Z is four. It should be noted here that the set period and the minimum number of days before empty Z may be different because they can be set independently of each other.

The set period that is a period basket and the minimum number of days before empty are parameters for creating a delivery plan and, by adjusting these parameters as appropriate, a delivery plan can be created in consideration of the overall volume of delivery. For example, by adjusting the parameters so as to extend the set period, a delivery plan becomes similar to a conventional delivery plan that is determined empirically without predicting the remaining amount and the replacement day. In contrast, by adjusting the parameters so as to shorten the set period, a delivery plan becomes more optimal than the conventional delivery plan.

When the set period is set to four days starting from tomorrow, the set period on the day corresponding to the number of elapsed days of 36 for the tank 21 is four days starting from the number of elapsed days of 37 to the number of elapsed days of 40.

With reference to the storing portion 13, the extracting portion 14 extracts the installation address of the tank for which the remaining amount is predicted to become zero on the day after the second set of days, which are (Z+1) days, after the set period (step ST4). When the tank delivery planning device 1 performs processing by setting Z to 4 and the set period to four days starting from the number of elapsed days of 37 to the number of elapsed days of 40 for the tank 21, the extracting portion 14 extracts the installation address of the tank for which the remaining amount is predicted to become zero on the day corresponding to the number of elapsed days of 45 for the tank 21, which is five days after the set period as illustrated in FIG. 4. The tank for which the installation address is extracted includes the tank 21. In addition, the installation address of another tank for which the remaining amount is predicted to become zero on the day corresponding to the number of elapsed days of 45 for the tank 21 is also extracted if it is present.

Next, the planning portion 15 creates a delivery plan for delivering a new tank to the address extracted by the extracting portion 14 within the set period, that is, the period from the day corresponding to the number of elapsed days of 37 to the day corresponding to the number of elapsed days of 40 for the tank 21 (step ST5). The planning portion 15 creates the delivery plan by solving a delivery planning problem (vehicle routing problem) that delivers the tank to the address extracted by the extracting portion 14 within the set period. Since there are various known methods for solving the delivery planning problem and the planning portion 15 may use such known methods to obtain a solution, details are not described.

It should be noted here that the delivery planning problem solved by the planning portion 15 has limiting conditions. The limiting conditions may be the work time of delivery persons, the number of delivery cars, road traffic regulations such as one-way traffic and usable travel lanes depending on the time periods, traffic jam information, or the like. For example, 8-hour work, 16-hour rest after the 8-hour work, and 8-hour-work are set as the work hours of delivery persons.

As described above, the tank delivery planning device 1 can accurately predict the future gas consumption amounts and the replacement days of the tanks 21 to 2N by obtaining the daily gas consumption amounts from the gas meters 31 to 3N. Since the replacement days of the tanks 21 to 2N can be predicted accurately to create a delivery plan, an efficient delivery plan can be obtained. Replacement of tanks based on such an efficient delivery plan enables the gas supply operator to eliminate the waste of delivery cost, reduce unnecessary inventory of gas remaining in recovered tanks, and improve efficiency. In particular, as the set periods in a delivery plan are shorter, the waste of delivery cost and the unnecessary inventory can be reduced more.

When the planning portion 15 cannot create a delivery plan in step ST5, that is, when an executable solution of the delivery planning problem cannot be obtained, the planning portion 15 relaxes the limiting conditions and solves the delivery planning problem again. For example, the planning portion 15 relaxes the limiting conditions by extending the work time of delivery persons or increasing the number of delivery cars.

Alternatively, when an executable solution of the delivery planning problem cannot be obtained in step ST5, the extracting portion 14 may extend the set period and extract again the installation address of the tank for which the amount of gas becomes zero on the day after the second set number of days from the extended set period or the planning portion 15 may solve the delivery planning problem again based on the extracted address and the extended set period.

Conventionally, a tank delivery plan was determined empirically. Accordingly, as the set period is extended, the delivery plan obtained by the tank delivery planning device 1 becomes similar to the conventional empirical delivery plan. Since the delivery efficiency and the unnecessary inventory of gas remaining in recovered tanks can be adjusted by changing the length of the set period, the gas supply operator can flexibly improve efficiency.

In addition, the prediction methods for the gas consumption amount and the replacement day described above are so-called heuristics prediction. However, heuristics prediction is apt to become inaccurate when the learning period includes exceptional days such as Golden Week holidays or year-end and New Year holidays. Accordingly, the tank delivery planning device 1 may perform prediction using a combination with a linear regression model or a nonlinear regression model instead of using only heuristics prediction.

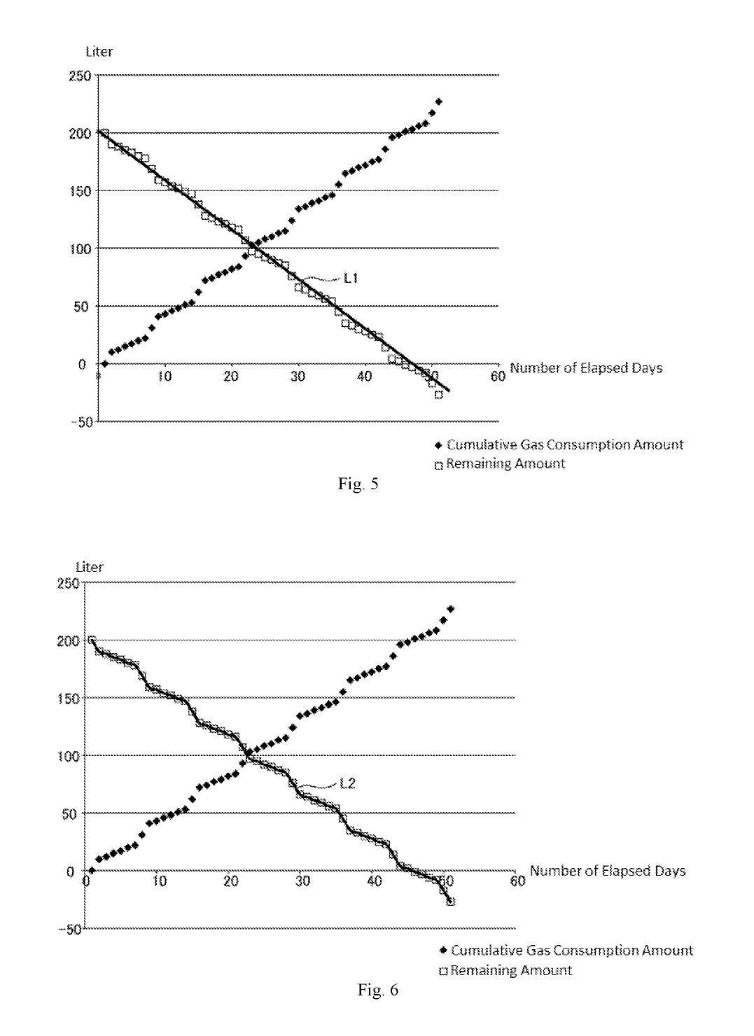

First, a prediction method using a combination with a linear regression model will be described. This linear regression model represents the relationship between the number of elapsed days, the day of the week, and the remaining gas amount in the tank as expression (1) below. When the tank 21 illustrated in FIGS. 3 and 4 is used as the target, modeling is performed as a straight line L1 illustrated in FIG. 5. It should be noted here that FIG. 5 also indicates the cumulative gas consumption amount. In addition, the section in which the remaining amount is approximately 0 and negative in FIG. 5 is an extrapolation section.

Y=β₀+β₁X₁+β₂X₂+ . . . +βₚXₚ+ϵ (1)

In expression (1), Y represents the remaining amount, X₁ to Xₚ represent the number of elapsed days, β₁ to βₚ each represents information (e.g., consumption) of the day of the week that has been converted into a dummy variable, and ϵ represents a starting gas amount in the tank.

When the gas consumption amount used for prediction by the consumption amount predicting portion 11 of the gas consumption amounts obtained by the acquisition portion 10 is the gas consumption amount of an exceptional day (that is, when the learning period includes an exceptional day), the replacement day predicting portion 12 corrects the remaining amount of the predicted day using the gas consumption amount of the exceptional day. The correction is performed using a linear regression model as described above, which can perform calculation based on the daily gas consumption amounts of, for example, the previous month. It should be noted here that the linear regression model used for correction is not limited to one that is based on the gas consumption of the previous month and only needs to be based on the gas consumption in a past period, so the linear regression model may be, for example, one that is based on the gas consumption of the month before the previous month as well as the previous month or one that is based on the gas consumption from when use of the tank was last started to when the tank was replaced.

For example, it is assumed that, when the replacement day predicting portion 12 calculates the future daily remaining amounts of the tank 21 for the first set number of days using the gas consumption amounts predicted by the consumption amount predicting portion 11, the remaining amount on a Thursday, two days later, is R1, but the Thursday in the learning period is an exceptional day. In this case, the replacement day predicting portion 12 separately calculates the remaining amount of a prediction target day D that is two days later (for which the remaining amount has been calculated to R1) using the linear regression model described above. This is also true of the other tanks 22 to 2N. It should be noted here that the prediction target day represents the day for which the consumption amount predicting portion 11 performs prediction and means each of the future days corresponding to the first set number of days.

When the remaining amount of the prediction target day D separately calculated using a linear regression model is assumed to be R2, the replacement day predicting portion 12 performs weighting as illustrated in expression (2) and calculates a correction value R of the remaining amount. Then, the remaining amount of the Thursday, two days later, is assumed to be the correction value R and the daily remaining amounts after the Thursday, two days later, are calculated.

R=aR1+bR2 (2)

It should be noted here that the total value of a and b equals 1.

Next, a predication method using a combination with a nonlinear regression model will be described. The nonlinear regression model represents the relationship between the number of elapsed days, the day of the week, and the remaining gas amount in the tank as expression (3) below. When the tank 21 illustrated in FIGS. 3 and 4 is used for learning, modeling is performed as a curve L2 illustrated in FIG. 6. It should be noted here that FIG. 6 also illustrates the cumulative gas consumption amount. In addition, the section in which the remaining amount is approximately 0 and negative in FIG. 6 is an extrapolation section.

y=f(x,β) (3)

In expression (3), y is a vector indicating the remaining amount, x is a vector indicating the number of elapsed days, and β indicates information of the day of the week.

As for, for example, the tank 21, the replacement day predicting portion 12 compares a current gas remaining amount R3 calculated by subtracting, from the capacity of the tank 21, the cumulative value of the gas consumption amount obtained by the acquisition portion 10 from the gas meter 31 with a current gas remaining amount R4 separately calculated using a nonlinear regression model between the number of elapsed days, the day of the week, and the gas remaining amount in the tank 21. This is also true of the other tanks 22 to 2N. The nonlinear regression model is calculated based on, for example, the daily gas consumption amounts of the previous month. It should be noted here that the nonlinear regression model is not limited to one that is based on the gas consumption of the previous month and only needs to be based on the gas consumption in a past period, so the nonlinear regression model may be, for example, one that is based on the gas consumption of the month before the previous month as well as the previous month or one that is based on the gas consumption from when use of the tank was last started to when the tank was replaced.

As a result of the comparison, when the remaining amount R3 is smaller than the remaining amount R4 and the remaining gas amount is reduced at higher speed than in a past period such as the previous month, the replacement day predicting portion 12 predicts the day on which the remaining amount becomes zero by performing correction that reduces the remaining amount by, for example, subtracting a certain value evenly from the remaining amounts of the prediction target days calculated using the gas consumption amounts predicted by the consumption amount predicting portion 11.

Alternatively, as a result of the comparison, when the remaining amount R3 is larger than the remaining amount R4 and the remaining gas amount is reduced at lower speed than in a past period such as the previous month, the replacement day predicting portion 12 predicts the day on which the remaining amount becomes zero by performing correction that increases the remaining amount by, for example, adding a certain value evenly to the remaining amounts of the prediction target days calculated using the gas consumption amounts predicted by the consumption amount predicting portion 11.

When the tank delivery planning device 1 performs prediction using a combination with a linear regression model or a nonlinear regression model, the delivery plan can be created by using the prediction result with high reliability.

In the above description, it is assumed that the tank delivery planning device 1 is constructed in a server managed by the gas supply operator or the like. However, when, for example, the memory capacity of the gas meters 31 to 3N is large, the consumption amount predicting portion 11 and the replacement day predicting portion 12 of the tank delivery planning device 1 may be constructed in the gas meters 31 to 3N and the day on which the remaining amount is predicted to become zero may be reported to the server managed by the gas supply operator or the like. In this case, the extracting portion 14 and the planning portion 15 are constructed in the server and the tank delivery planning device 1 is constructed across the server and the gas meters 31 to 3N.

As described above, according to embodiment 1, the planning portion 15 creates a delivery plan using accurate replacement days obtained by appropriately predicting the user's future consumption behaviors using the consumption amount predicting portion 11 and the replacement day predicting portion 12. An efficient delivery plan can be obtained by creating a delivery plan using the accurately predicted replacement days.

In addition, the work time of delivery persons or the number of delivery cars is set as the limiting conditions of the delivery planning problem. This can create a delivery plan while setting available delivery persons and delivery cars.

In addition, when an executable solution of the delivery planning problem cannot be obtained, the extracting portion 14 and the planning portion 15 may extend the set period and perform processing again. This can obtain an executable delivery plan.

In addition, when an executable solution of the delivery planning problem cannot be obtained, the planning portion 15 may relax the limiting conditions and perform processing again. This can obtain an executable delivery plan.

In addition, the tank delivery planning device 1 is provided in a server communicably connected to the gas meters 31 to 3N that measure the amounts of gas flowing out of the tanks 21 to 2N. This can create a delivery plan by centrally managing the day on which the tank of LP gas is replaced on the server.

It should be noted here that any component of the embodiment can be modified or any component of the embodiment can be omitted within the scope of the invention.

### DESCRIPTION OF REFERENCE NUMERALS AND SIGNS

1: tank delivery planning device

5: communication line

10: acquisition portion

11: consumption amount predicting portion

12: replacement day predicting portion

13: storing portion

14: extracting portion

15: planning portion

21 to 2N: tank

31 to 3N: gas meter

41 to 4N: gas combustion chamber

1. A tank delivery planning device for Liquefied Petroleum (LP) gas, comprising:
an acquisition portion that obtains daily gas consumption amounts from a gas consumption measuring device;
a consumption amount predicting portion that predicts future daily gas consumption amounts for a first set number of days using a corresponding one or more latest gas consumption amounts of one or more same days of a week among the gas consumption amounts obtained by the acquisition portion;
a replacement day predicting portion that predicts a day on which a remaining gas amount in a tank becomes zero using the daily gas consumption amounts obtained by the acquisition portion and the future daily gas consumption amounts for the first set number of days predicted by the consumption amount predicting portion;
an extracting portion that extracts an installation address of the tank for which the day on which the remaining gas is predicted to become zero by the replacement day predicting portion is a second set of days after a set period; and
a planning portion that solves a delivery planning problem for delivering a new tank within the set period to the address extracted by the extracting portion and creates a delivery plan.

2. The tank delivery planning device for LP gas according to claim 1,
wherein work time of a delivery person or a number of delivery cars is set as a limiting condition of the delivery planning problem.

3. The tank delivery planning device for LP gas according to claim 2,
wherein, when an executable solution of the delivery planning problem is not obtained, the extracting portion and the planning portion extend the set period and perform processing again.

4. The tank delivery planning device for LP gas according to claim 2,
wherein, when an executable solution of the delivery planning problem is not obtained, the planning portion relaxes the limiting condition and performs processing again.

5. The tank delivery planning device for LP gas according to claim 1,
wherein, when an executable solution of the delivery planning problem is not obtained, the extracting portion and the planning portion extend the set period and perform processing again.

6. The tank delivery planning device for LP gas according to claim 1, wherein the tank delivery planning device is provided in a server communicably connected to a gas meter (as the gas consumption measuring device) that measures a gas amount flowing out of the tank.

7. A tank delivery planning method for LP gas comprising:
obtaining, by an acquisition portion, daily gas consumption amounts;
predicting, by a consumption amount predicting portion, future daily gas consumption amounts for a first set number of days using a corresponding one or more latest gas consumption amounts of one or more same days of a week among the gas consumption amounts obtained by the acquisition step;
predicting, by a replacement day predicting portion, a day on which the remaining gas amount in the tank becomes zero using the daily gas consumption amounts obtained in the obtaining step and the future daily gas consumption amounts for the first set number of days predicted in the consumption amount predicting step;
extracting, by an extracting portion, an installation address of the tank for which the day on which the remaining gas is predicted to becomes zero in the replacement day predicting step is a second set of days after a set period; and
solving, by a planning portion, a delivery planning problem for delivering a new tank within the set period to the address extracted in the extracting step and creating a delivery plan.
